(19) United States
(12) Patent Application Publication
(10) Pub. No.: US 2025/0030460 A1
(43) Pub. Date: Jan. 23, 2025

(54) CONFIGURING AN INTELLIGENT REFLECTING SURFACE (IRS)

(71) Applicant: Telefonaktiebolaget LM Ericsson (publ), Stockholm (SE)

(72) Inventors: Behrooz MAKKI, Pixbo (SE); Gabor FODOR, Hässelby (SE); André L. F. DE ALMEIDA, Fortaleza (BR); Francisco H. C. NETO, Fortaleza-CE (BR)

(73) Assignee: Telefonaktiebolaget LM Ericsson (publ), Stockholm (SE)

(21) Appl. No.: 18/714,399

(22) PCT Filed: Dec. 3, 2021
(86) PCT No.: PCT/EP2021/084253

§ 371 Date: May 29, 2024

(51) Int. Cl. H04B 7/04; H04W 16/26; H04W 16/28; H04W 28/02

(52) U.S. Cl. CPC H04B 7/04013; H04W 16/26; H04W 16/28; H04W 28/0236

(57) ABSTRACT

A method (200) for configuring a set of reflectors (120), wherein the set of configurable reflectors are provided by a set of one or more intelligent reflecting surfaces, IRSs (105). The method includes determining (s202) a first set of one or more IRS configuration parameters, wherein the first set of IRS configuration parameters comprises at least one of; (a) a first link quality metric for a first link between a first CD and an access network node, wherein the first link comprises a first channel between the first CD and the set of one or more IRSs and a second channel between the set of one or more IRSs and the access network node; (b) a first quality-of-service, QoS, requirement for the first CD; or (c) a transmission status for the first CD. The method also includes, based on the first set of IRS configuration parameters, partitioning (s204) the set of configurable reflectors, wherein the partitioning comprises defining at least a first subset of the set of configurable reflectors and a second subset of the set of configurable reflectors. The method also includes configuring (s206) the first subset of the configurable reflectors and configuring the second subset of the configurable reflectors.

### TECHNICAL FIELD

Disclosed are embodiments related to intelligent reflecting surfaces (IRSs).

### BACKGROUND

An intelligent reflecting surface (IRS) (also known as reconfigurable intelligent surface (RIS)) is a device that is able to control the properties of electromagnetic waves and, thereby, dynamically shape a radio propagation environment (see, e.g., reference [1]). IRSs are regarded as a promising emerging hardware technology to improve the spectrum and energy efficiency of wireless networks by reconfiguring the propagation environment of electromagnetic waves.

An IRS generally comprises an array of low-cost and low-complexity signal reflectors. The reflectors are configurable (i.e., programmable). That is, for example, the phases of the reflectors can be adjusted in real-time so that an impinging signal can be re-phased by adjusting the phases of the reflectors. This re-phasing is done to efficiently re-direct the impinging signal towards an in-range receiver (e.g., a communication device (CD)). (See, e.g., reference [1]).

In many cases, the programmability is achieved by equipping the IRS with a network interface and a processing unit (e.g., microcontroller, microprocessor, etc.). The network interface enables the establishment of a control link between the IRS and a network node (e.g., access point (AP), CD, etc.) through which the IRS can receive feedback, for example, in terms of Signal-to-Noise Ratio or Signal-to-Interference-plus-Noise-Ratio (the acronym SNR is used broadly to encompass either ratio) and/or instructions (e.g., how to adjust the phases of reflectors). In some configurations, the processing unit allows the IRS to execute pre-computed instructions, while in other configurations the processing unit computes-and-executes instructions based on the received feedbacks.

IRS deployment aims to increase coverage (e.g., in terms of SNR) at network edge and in poor coverage areas (e.g., indoor environments) and to improve end-user performance (e.g., data rate). IRS deployment is more scalable than massive Multiple-Input-Multiple-Output (MIMO) deployment and heterogeneous network (e.g., macro cells and small cells) deployment in terms of complexity, interference management, power consumption, and costs. Use cases include IRS deployment for smart cities (e.g., on the external façade of buildings) and smart indoor environments (e.g., in private homes and large indoor open spaces such as malls and airports).

Algorithms to configure a IRS have been proposed. One such algorithm is referred to as “RFocus” (see V. Arun 2019 (reference [3])). RFocus performs the IRS configuration based on SNR feedbacks. Results confirm that SNR gains are attainable using the RFocus algorithm (see reference [4]). The algorithm allows for activating a subset of reflectors to improve the SNR at the receiver end. It performs several iterations to search for the subset of reflectors to activate. It has been shown that power can be focused on a point in space by such a simple on-off strategy.

The Third Generation Partnership Project (3GPP) may consider IRS-assisted communication as a possible technology to be considered in a future 3GPP release as a low complexity method for capacity enhancement and coverage extension (see, e.g., references [2] and [3]).

### SUMMARY

Certain challenges presently exist. For example, IRSs can be utilized by different nodes simultaneously where each IRS can be partitioned into a number of sub-IRSs each one boosting the performance of communication between two nodes, but this may lead to additional interference at the receivers, message decoding failure, and possibly multiple hybrid automatic repeat request (HARQ) based retransmissions.

Accordingly, there is provided a method for configuring a set of configurable reflectors, wherein the set of configurable reflectors are provided by a set of one or more IRSs. The method includes determining a first set of one or more IRS configuration parameters, wherein the first set of IRS configuration parameters comprises at least one of: (a) a first link quality metric for a first link between a first CD and an access network node, wherein the first link comprises a first channel between the first CD and the set of one or more IRSs and a second channel between the set of one or more IRSs and the access network node; (b) a first quality-of-service, QoS, requirement for the first CD; or (c) a transmission status for the first CD. The method also includes, based on the first set of IRS configuration parameters, partitioning the set of configurable reflectors, wherein the partitioning comprises defining at least a first subset of the set of configurable reflectors and a second subset of the set of configurable reflectors. The method also includes configuring the first subset of the configurable reflectors and configuring the second subset of the configurable reflectors.

There is also provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium.

There is also provided a network node that is configured to perform the methods disclosed herein. In some embodiments, the network node comprises a storage unit and processing circuitry coupled to the storage unit, wherein the network node is configured to perform the methods disclosed herein.

An advantage of the embodiments disclosed herein is that they enable adaptive transmission and reception/decoding in IRS-assisted networks, where the IRSs partitioning and configurations are dynamically adapted based on, for example, the message decoding status and/or the channel quality of different links. Such a setup leads to an improved fairness in the network as well as better average end-to-end data transmission delay. Finally, the intelligent IRS partitioning gives the chance to improve the performance of the CD with a weak channel quality while not losing the performance of the CD with a strong channel quality.

### BRIEF DESCRIPTION OF THE DRAWINGS

The accompanying drawings, which are incorporated herein and form part of the specification, illustrate various embodiments.

FIG. 1 illustrates a communication system according to an embodiment.

FIG. 2 is a flowchart illustrating a process according to some embodiments.

FIG. 3 is a block diagram of a network node according to some embodiments.

### DETAILED DESCRIPTION

As noted above, if an IRS is not properly configured, use of the IRS may lead to additional interference at the receivers, message decoding failure, and possibly multiple HARQ-based retransmissions. For this reason, it is beneficial to develop techniques to reduce the effect of interference.

Also, explained in the following, one can utilize the information about the message decoding status, as well as the channel quality and communication needs, at different nodes to dynamically adapt an IRS partitioning between the links during the retransmissions or HARQ-based retransmissions, resulting in an improved network fairness.

This disclosure describes, among other things, an efficient IRS-assisted communication setup, possibly, using HARQ. In one embodiment, based on the message decoding status and/or the channels quality/communication needs at different links sharing the same IRS, the receiver design and the IRS partitioning (and its corresponding configurations) are adapted jointly in different transmissions or HARQ-based retransmission rounds. Moreover, the data transmission, e.g., beamforming/power allocation, at the transmitters as well as the signal decoding and buffering schemes at the receivers may be adapted to reduce the effect of interference. In this way, the network end-to-end data transmission delay and the fairness will be improved.

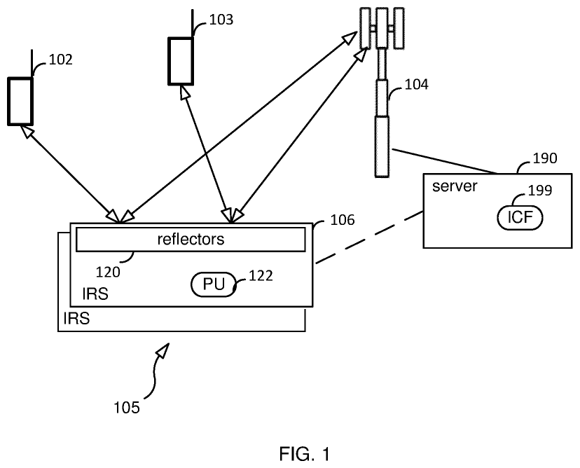

FIG. 1 illustrates a communication system 100 according to an embodiment. Communication system includes: an access network node 104 (also referred to herein as “access point (AP)”) (e.g., a radio access network (RAN) node a cellular network (e.g., a base station)), a first communication device (CD) 102, a second CD 103 and a set of one or more IRSs 105, which includes IRS 106 and which comprises a set of configurable reflectors 120 (or simply reflectors 120 for short) and a processing unit 122. As used herein a “CD” is any device (e.g., mobile phone, router, sensor, appliance, vehicle, smart meter, computer) capable of wireless communication with AP 104. As shown in FIG. 1, a signal transmitted by CD 102 impinges on IRS 106 and IRS 106 is configured to reflect the impinging signal toward AP 104; likewise, a signal transmitted by CD 102 impinges on IRS 106 and IRS 106 is configured to reflect the impinging signal toward AP 104.

As also shown in FIG. 1, communication system 100 may include a computer 190 (a.k.a., “server”) that executes an IRS control function (ICF) 199 that implements a method for configuring reflectors 120. For example, ICF 199 is configured to select the configuration(s) for configuring one or more reflectors of IRS 106. In other embodiments, ICF may be component of AP 104 or UE 102.

As demonstrated in FIG. 1, IRS is a promising cost-effective technology for boosting the spectrum and energy efficiency in future wireless communication systems. Specifically, the set of one or more IRSs 105 is able to establish proper channel responses by controlling the wireless propagation environment via its large set of reflectors 120. For instance, considering FIG. 1, and assuming that CD 103 and AP 104 are not communicating with each other, the signal transmitted by CD 102 and received at AP 104 is given by:

$$Y = \sqrt{{P}_{C D}} {h}_{I R S - A P}^{H} Θ {h}_{C D - I R S} + z \qquad ( Eq . 1 )$$

Here, z is the additive noise at the AP. Also, h_{IRS-AP}^{H} and h_{CD-IRS} are the IRS-AP and the CD-IRS channel gains, respectively. Then, Θ is the IRS matrix, which is determined to optimize, e.g., the received SNR. Finally, P_{CD} is the CD 102 transmission power.

An IRS is neither a passive reflecting surface nor a relay. This is because, as opposed to a passive surface, an IRS needs to be activated by the AP (or another network node) and its phase shifter parameters should be properly set based on the UEs to be served by the AP, channel realizations, etc. In contrast to a relay node, which receives the signal as an AP and, after some process, forwards the data in the next time slot(s) with some scheduling (thus, basically the CD-relay and the relay-AP are separated links with, e.g., two independent RACH processes), an IRS reflects the CD signal towards the AP with no extra delay, etc. and, for example, only a single RACH process is required for the CD-IRS-AP chain.

Moreover, the flexibility of the IRS, reflected by Θ in equation 1, is highly dependent on the size and the hardware properties of the IRS and the parameter setting of the IRS affects the CD transmit power/beamforming accordingly.

In an IRS-assisted communication setup, the set of reflectors 120 of IRS(s) 105 can be divided to, in effect, create a number of sub-IRSs each one responsible to boost the performance of a specific link. For example, based on the link quality and a CD's QoS requirements, the set of reflectors 120 can be partitioned into at least two subsets: a first subset of reflectors (a.k.a., first partition) to serve a first link between CD 102 and AP 104 and a second subset of reflectors (a.k.a., second partition) to serve second link between CD 103 and AP 104. Basically, the IRS partitioning means that the IRS matrix for each partition (i.e., each subset of reflectors) is optimized only to maximize the performance of its associated link, at the cost of possible interference in the other link. That is, the IRS matrix for the first partition is optimized to maximize the SNR of the CD 102-IRS-AP link, while the IRS matrix for the second partition is determined such that the SNR of the CD 103-IRS-AP link is maximized. However, depending on the quality of the links, such a partitioning may lead to multiple HARQ-based retransmissions which are preferred to be avoided in sake of reducing the end-to-end transmission delay. An IRS matrix is a set of one or more values, where each value specifies a characteristic of one of the reflectors. For example, the characteristic may be: i) the phase shift produced by the reflector, ii) whether the reflector changes the polarization of the impinging signal, iii) a frequency shift produced by the reflector, iv) the degree to which the reflector modifies the amplitude of the impinging signal, v) angle of departure, etc.

This disclosure describes an adaptive IRS partitioning scheme in the cases, possibly, using HARQ. Here, an objective is to improve the performance of the UEs with weak channel quality while not losing the quality-of-service (QOS) of the UEs with a strong channel quality. In this way, the proposed scheme results in an improved network fairness and reduces the average end-to-end data transmission delay. The proposed scheme can be explained through the example given below. Note that, for simplicity, the setup is explained for the cases with HARQ. However, the same approach is applicable in a more general case with different channel quality of the links and/or UEs requirements

In a first step, based on the CD 102's QOS requirements, CD 103's QoS requirements, and/or the link qualities, the set of reflectors 120 is divided into at least two subsets (e.g., a first subset of the reflectors 120 (“first partition”) and a second disjoint subset of the reflectors 120 (“second partition”)). For instance, in one example, the number of reflectors included in the first and second partitions (a.k.a., “initial partition sizes”) are based on the relative QoS requirements of CD 102 and U 103. As a specific example, assuming that CD 102 has higher QoS requirements than CD 103, then the number of reflectors included in the first partition is greater than the number of reflectors included in the second partition (i.e., CD 102 gets a larger IRS partition). As another example, if CD 102 is further away from AP 104 than CD 103 then CD 102 will again get a larger IRS partition. As another example, if CD 102 has a lower signal power (received or transmitted) than CD 103, then CD 102 may be allocated a larger IRS partition than CD 103.

In another step, an IRS matrix is determined for each partition (such an IRS matrix is referred to as a “sub-IRS matrix”). Each sub-IRS matrix may be based on the link quality of its associated link as is known in the art. That is, each IRS partition can be treated like a conventional IRS and can be configured using conventional techniques (see, e.g., reference [1]).

In another step, which may come before or after the previously described step, transmission parameters (e.g., beamforming parameters, transmission power, etc). are determined for each CD. In some embodiments, at least some of the transmission parameters are based on the associated sub-IRS matrix. In one embodiment, such configurations are determined by AP 104, or in general, a network controller, and the IRS and the UEs are informed accordingly.

After the transmission parameters a determined, then, using these parameter settings, CD 102 transmits to AP 104 a first signal encoding a first message and in the same slot (e.g., Slot 1) CD 103 also transmits to AP a second signal encoding a second message (e.g., the transmissions may occur during the same orthogonal frequency-division multiplexing (OFDM) symbols). In additional to the first and second signals being transmitted in the same slot, each CD may use the same frequency resources (e.g. the same subcarriers) to transmit their respective signals.

Because the signals are transmitted in the same slot, AP 104 receives an accumulated signal (i.e., the first signal combined with the second signal), and then attempts to decode the first and second messages.

Let us assume that AP 104 can correctly decode the message of CD 102 but it fails to decode the message of CD 103. In this case, the following procedures may be performed. AP 104 sends a positive acknowledgment (ACK) to CD 102 and negative acknowledgment (NACK) to CD 103. Also, using successive interference cancellation (SIC), AP 104 removes the decoded signal of CD 102 from the accumulated received signal, and buffers the interference-free but un-decoded signal of CD 103. Based on the message decoding status of the links and the order of the required retransmission, AP 104 re-partitions reflectors 120 (i.e., establishes a new partition for CD 102 and/or a new partition for CD 103), determines a new IRS matrix for each new partition, and determines new transmission parameters (e.g., beamforming/transmission powers) for the UEs. Then, along with the ACK/NACK, the AP informs the IRS and the UEs about the new IRS partitioning, the IRS matrices of the new partitions, as well as the UEs adapted transmission parameters.

During a subsequent transmission opportunity, CD 102 sends to AP 104 a new signal encoding a third message while CD 103 retransmits the second message using the new transmission parameter settings. AP 104 then receives a new accumulated signal and performs the following process. First, AP 104 combines the buffered interference-free signal of CD 103 and the new accumulated interference-affected signal (received in Slot 2) to decode the message of CD 103 (i.e., the second message). Then, with a successful decoding of the signal of CD 103, AP 104 uses SIC to remove the signal of CD 103 from the accumulated signal of Slot 2, and decodes the new signal of CD 102 interference-free. Such an adaptation continues until the signal of CD 103 is correctly decoded.

In this way, adaptation of the IRS partitioning and the UEs transmission parameters (e.g., transmission power, beamforming and/or data rate) gives the chance to correctly decode the signal of CD 103 with few retransmissions. This will lead to low end-to-end transmission delay for CD 103. On the other hand, while CD 102 receives a smaller portion of the IRS in Slot 2, this is compensated by decoding its signal interference-free. As a result, the joint adaptation of the IRS partitioning and decoding scheme makes it possible to boost the performance of CD 103 while the QoS provided to CD 102 is not affected much. In this way, the proposed scheme results in an improved end-to-end transmission delay and fairness in the network.

In one embodiment, a set of specific IRS configuration strategies are predefined. For example, IRS 106 may have a fixed set of IRS matrices to choose from, thus determining a sub-IRS matrix for a partition may comprise selecting one of the pre-defined matrices. As another example, one strategy is to have all reflectors within a partition have the same or nearly the same phase and/or amplitude. Yet another strategy is to minimize interference. In one embodiment, each IRS configuration strategy is associated with a set of transmission parameters that includes, for example, a timing advance value, a beamforming setting, and/or transmit power setting. In a one embodiment, the selected IRS configuration strategy is signaled from the network node to the CD using cell-specific RRC signaling, CD-specific RRC signaling, medium access control (MAC) control element (CE) signaling, or downlink control information (DCI) signaling (e.g., included in the control signaling used for scheduling a data transmission/reception).

In one embodiment, the appropriate IRS partitioning/configuration and the UEs transmission parameters associated with each retransmission combination of the UEs are determined offline and saved in, e.g., a network controller. Then, with a possible retransmission scenario, the AP, IRS and the UEs switch immediately to a predefined configuration.

In one embodiment, either or both of CD 102 and CD 103 is an integrated access and backhaul (IAB) node, where, for instance, an IAB node connects to its parent IAB using IRSs.

The examples given above illustrate the cases with probable message decoding failure in some links and the need for HARQ-based retransmissions where the IRS partitioning is adapted based on the message decoding status of different links. However, this is not necessary, as the same approach can be applied in the more general cases with different UEs requirements and/or channel qualities. Particularly, changing the IRSs partitioning can be performed on a larger time scale than HARQ retransmissions since a changed surface area also implies a changed channel and correspondingly, a changed MCS. Here, using reference signals (RSs), such as channel state information RS (CSI-RS), sounding RS (SRS), etc., the AP 104 can find out the channel quality of different links.

Accordingly, in a general way, the following procedure can be applied for IRS partitioning. Step 1: Obtain channel information indicating an estimated channel quality of a link between the IRS and a transmitting or receiving device (e.g., CD 102). For example, perform measurements for CD links via IRS using CSI-RS, SRS or other reference signals, or message decoding status, Step 2: Based on communication needs and/or the estimated channel quality and/or number of retransmission (e.g., a CD that received a NACK (or multiple NACKS) may get bigger portion of IRS), determine partition size for the CD. Step 3: For each partition, determine an IRS matrix. Step 4: Send the IRS matrices to the IRS and send configuration information (e.g., transmission parameters) to the UEs. Step 5: communicate with UEs using the new configurations.

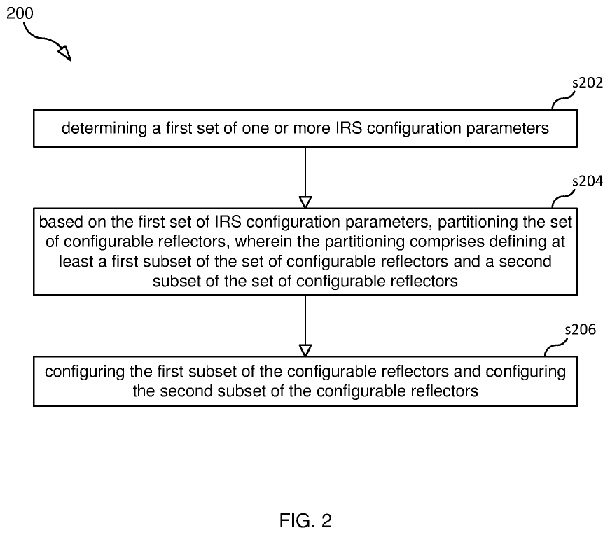

FIG. 2 is a flowchart illustrating a process 200, according to an embodiment, that is performed by a network node (e.g., AP 400, CD 102, server 190) for configuring a set of reflectors, wherein the set of reflectors are provided by as set of one more IRSs, which set includes IRS 106. Process 200 may begin in step s202.

Step s202 comprises determining a first set of one or more IRS configuration parameters, wherein the first set of IRS configuration parameters comprises at least one of: (a) a first link quality metric for a first link between a first CD (e.g., CD 102) and an access network node (e.g., AP 104), wherein the first link comprises a first channel between the first CD and the set of one or more IRSs and a second channel between the set of one or more IRSs and the access network node; (b) a first quality-of-service, QoS, requirement for the first CD; or (c) a transmission status (e.g., number of retransmissions) for the first CD.

Step s204 comprises, based on the first set of IRS configuration parameters, partitioning the set of configurable reflectors, wherein the partitioning comprises defining at least a first subset of the set of configurable reflectors and a second subset of the set of configurable reflectors.

Step s206 comprises after defining the first and second subsets, configuring the first subset of the configurable reflectors and configuring the second subset of the configurable reflectors.

In some embodiments, the first subset of configurable reflectors comprises a first reconfigurable reflector the method further comprises determining a phase shift for the first reconfigurable reflector, and configuring the first subset of configurable reflectors comprises configuring the first configurable reflector to produce the determined phase shift.

In some embodiments, the first subset of configurable reflectors comprises a first reconfigurable reflector, and configuring the first subset of configurable reflectors comprises placing the first configurable reflector in an off state to prevent the first configurable reflector from reflecting an impinging signal.

In some embodiments, configuring the first subset of configurable reflectors comprises obtaining a first set of link quality metrics, wherein each link quality metric in the first set of link quality metrics indicates a quality of the first link between the first CD and the access network node, and configuring the second subset of configurable reflectors comprises obtaining a second set of link quality metrics, wherein each link quality metric in the second set of link quality metrics indicates a quality of the second link between the second CD and the access network node.

In some embodiments the method also includes determining a second set of one or more IRS configuration parameters, wherein the second set of IRS configuration parameter comprises at least one of: (a) a second link quality metric for a second link between a second CD and the access network node, wherein the second link comprises a third channel between the second CD and the one or more IRSs and a fourth channel between the one or more IRSs and the access network node; (b) a second QoS requirement for the second CD; or (c) a transmission status for the second CD, wherein partitioning the set of configurable reflectors comprises partitioning the set of configurable reflectors based on both the first set of IRS configuration parameters and the second set of IRS configuration parameters.

In some embodiments the method also includes: the access network node receiving, during a first time slot, a first accumulated signal comprising a first message transmitted by the first CD and a second message transmitted by the second CD; the access network node decoding from the received accumulated signal the second message transmitted by the second CD, but the access network node not being able to decode from the received accumulated signal the first message transmitted by the first CD; in response to being able to decode the second message but not the first message, the access network node triggering an ICF (e.g., ICF 199) to re-partition the set of configurable reflectors and transmitting a negative acknowledgement (NACK) message to the first CD for causing the first CD to retransmit the first message.

In some embodiments, repartitioning the set of configurable reflectors comprises defining at least a third subset of the set of configurable reflectors and a fourth subset of the set of configurable reflectors, and the method further comprises, after defining the third and fourth subsets, configuring the third subset of the configurable reflectors and configuring the fourth subset of the configurable reflectors.

In some embodiments, the third subset of the configurable reflectors comprises each reflector that was included in the first subset of the configurable reflectors and one or more configurable reflectors that were included in the second subset of the configurable reflectors.

In some embodiments, the method also includes, in response to being able to decode the second message but not the first message, the access network node removing the decoded second message from the received accumulated signal to produce an interference-free signal encoding the first message and buffering the interference-free signal.

In some embodiments, the method also includes, after sending the NACK message to the first CD, the access network node receiving, during a second time slot, a second accumulated signal comprising the first message; the access network node combining the buffered interference-free signal with the second accumulated signal to produce a combined signal; and the access network node attempting to decode the first message from the combined signal.

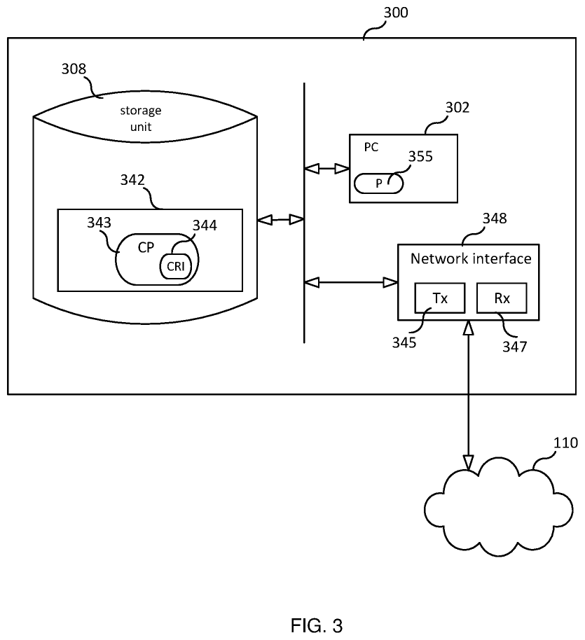

FIG. 3 is a block diagram of network node 300, according to some embodiments, that can implement any one or more of the network nodes described herein (e.g., AP 104, CD 102, server 190). That is, network node 300 can perform the above described methods. As shown in FIG. 3, network node 300 may comprise: processing circuitry (PC) 302, which may include one or more processors (P) 355 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., network node 300 may be a distributed computing apparatus); at least one network interface 348 comprising a transmitter (Tx) 345 and a receiver (Rx) 347 for enabling network node 300 to transmit data to and receive data from other nodes connected to a network 110 (e.g., an Internet Protocol (IP) network) to which network interface 348 is connected (directly or indirectly) (e.g., network interface 348 may be wirelessly connected to the network 110, in which case network interface 348 is connected to an antenna arrangement); and a storage unit (a.k.a., “data storage system”) 308, which may include one or more non-volatile storage devices and/or one or more volatile storage devices. In embodiments where PC 302 includes a programmable processor, a computer readable medium (CRM) 342 may be provided. CRM 342 stores a computer program (CP) 343 comprising computer readable instructions (CRI) 344. CRM 342 may be a non-transitory CRM, such as, magnetic media (e.g., a hard disk), optical media, memory devices (e.g., random access memory, flash memory), and the like. In some embodiments, the CRI 344 of computer program 343 is configured such that when executed by PC 302, the CRI causes network node 300 to perform steps described herein (e.g., steps described herein with reference to the flow charts). In other embodiments, network node 300 may be configured to perform steps described herein without the need for code. That is, for example, PC 302 may consist merely of one or more ASICs. Hence, the features of the embodiments described herein may be implemented in hardware and/or software.

### Conclusion

The adaptive IRS partitioning and updating the configurations (e.g., IRS matrices) for the IRS partitions based on, for example, the message decoding status, channel quality, and/or the UEs' communication needs as described herein provides several advantages, such as an improved end-to-end transmission delay and fairness in the network.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] M. Di Renzo, A. Zappone, M. Debbah, M.-S. Alouini, C. Yuen, J. de Rosny, and S. Tretyakov, “Smart Radio Environments Empowered by Reconfigurable Intelligent Surfaces: How It Works, State of Research, and The Road Ahead,” IEEE J. Sel. Areas Commun., vol. 38, no. 11, pp. 2450-2525, 2020.

1[2] RWS-210300, “NR repeaters and Reconfigurable Intelligent Surface,” 3GPP TSG RAN Rel-18 workshop, June 2021.
[3] RWS-210019, “NR Smart Repeaters for Rel 18,” 3GPP TSG RAN Rel18 workshop, June 2021.
[4] V. Arun and H. Balakrishnan, “RFocus: Practical Beamforming for Small Devices,” USENIX 2019.

1. A method for configuring a set of configurable reflectors, wherein the set of configurable reflectors are provided by a set of one or more intelligent reflecting surfaces, IRSs (105) (IRSs), the method comprising:
determining a first set of one or more IRS configuration parameters, wherein the first set of IRS configuration parameters comprises at least one of: (a) a first link quality metric for a first link between a first communication device (CD), and an access network node, wherein the first link comprises a first channel between the first CD and the set of one or more IRSs and a second channel between the set of one or more IRSs and the access network node; (b) a first quality-of-service (QoS) requirement for the first CD; or (c) a transmission status for the first CD; and
based on the first set of IRS configuration parameters, partitioningthe set of configurable reflectors, wherein the partitioning comprises defining at least a first subset of the set of configurable reflectors and a second subset of the set of configurable reflectors; and
after defining the first and second subsets, configuring the first subset of the configurable reflectors and configuring the second subset of the configurable reflectors.

2. The method of claim 1, wherein
the first subset of configurable reflectors comprises a first reconfigurable reflector, the method further comprises determining a phase shift for the first reconfigurable reflector, and
configuring the first subset of configurable reflectors comprises configuring the first configurable reflector to produce the determined phase shift.

3. The method of claim 1, wherein
the first subset of configurable reflectors comprises a first reconfigurable reflector, and
configuring the first subset of configurable reflectors comprises placing the first configurable reflector in an off state to prevent the first configurable reflector from reflecting an impinging signal.

4. The method of claim 1, wherein
configuring the first subset of configurable reflectors comprises obtaining a first set of link quality metrics, wherein each link quality metric in the first set of link quality metrics indicates a quality of the first link between the first CD and the access network node, and
configuring the second subset of configurable reflectors comprises obtaining a second set of link quality metrics, wherein each link quality metric in the second set of link quality metrics indicates a quality of the second link between the second CD and the access network node.

5. The method of claim 1, further comprising:
determining a second set of one or more IRS configuration parameters, wherein the second set of IRS configuration parameter comprises at least one of: (a) a second link quality metric for a second link between a second CD and the access network node, wherein the second link comprises a third channel between the second CD and the set of one or more IRSs and a fourth channel between the set of one or more IRSs and the access network node; (b) a second QoS requirement for the second CD; or (c) a transmission status for the second CD, wherein
partitioning the set of configurable reflectors comprises partitioning the set of configurable reflectors based on both the first set of IRS configuration parameters and the second set of IRS configuration parameters.

6. The method of claim 5, further comprising:
the access network node receiving, during a first time slot, a first accumulated signal comprising a first message transmitted by the first CD and a second message transmitted by the second CD;
the access network node decoding from the received accumulated signal the second message transmitted by the second CD, but the access network node not being able to decode from the received accumulated signal the first message transmitted by the first CD; and
in response to being able to decode the second message but not the first message, the access network node triggering an IRS control function, ICF, to re-partition the set of configurable reflectors and transmitting a negative acknowledgement, NACK, message to the first CD for causing the first CD to retransmit the first message.

7. The method of claim 6, wherein
repartitioning the set of configurable reflectors comprises defining at least a third subset of the set of configurable reflectors and a fourth subset of the set of configurable reflectors, and
the method further comprises, after defining the third and fourth subsets, configuring the third subset of the configurable reflectors and configuring the fourth subset of the configurable reflectors.

8. The method of claim 7, wherein
the third subset of the configurable reflectors comprises each reflector that was included in the first subset of the configurable reflectors and one or more configurable reflectors that were included in the second subset of the configurable reflectors.

9. The method of claim 6, further comprising, in response to being able to decode the second message but not the first message, the access network node removing the decoded second message from the received accumulated signal to produce an interference-free signal encoding the first message and buffering the interference-free signal.

10. The method of claim 9, further comprising
after sending the NACK message to the first CD, the access network node receiving, during a second time slot, a second accumulated signal comprising the first message; and
the access network node combining the buffered interference-free signal with the second accumulated signal to produce a combined signal; and
the access network node attempting to decode the first message from the combined signal.

11. A non-transitory computer readable medium storing a computer program comprising instructions which when executed by processing circuitry of a network node causes the network node to perform the method of claim 1.

12. (canceled)

13. A network node for configuring a set of configurable reflectors, wherein the set of configurable reflectors are provided by a set of one or more intelligent reflecting surface (IRSs), the network node-being configured to comprising:
a storage unit; and
processing circuitry coupled to the storage unit, wherein the network node is configured to perform a method comprising.
determining a first set of one or more IRS configuration parameters, wherein the first set of IRS configuration parameters comprises at least one of: (a) a first link quality metric for a first link between a first communication device (CD), and an access network node, wherein the first link comprises a first channel between the first CD and the set of one or more IRSs and a second channel between the set of one or more IRSs and the access network node; (b) a first quality-of-service (QoS) requirement for the first CD; or (c) a transmission status for the first CD; and
based on the first set of IRS configuration parameters, partitioning the set of configurable reflectors, wherein the partitioning comprises defining at least a first subset of the set of configurable reflectors and a second subset of the set of configurable reflectors; and
after defining the first and second subsets, configuring the first subset of the configurable reflectors and configuring the second subset of the configurable reflectors.

14. The network node of claim 13, wherein
the first subset of configurable reflectors comprises a first reconfigurable reflector,
the method further comprises determining a phase shift for the first reconfigurable reflector, and
configuring the first subset of configurable reflectors comprises configuring the first configurable reflector to produce the determined phase shift.

15. The network node of claim 13, wherein
the first subset of configurable reflectors comprises a first reconfigurable reflector, and
configuring the first subset of configurable reflectors comprises placing the first configurable reflector in an off state to prevent the first configurable reflector from reflecting an impinging signal.

16. The network node of claim 13, wherein
configuring the first subset of configurable reflectors comprises obtaining a first set of link quality metrics, wherein each link quality metric in the first set of link quality metrics indicates a quality of the first link between the first CD and the access network node, and
configuring the second subset of configurable reflectors comprises obtaining a second set of link quality metrics, wherein each link quality metric in the second set of link quality metrics indicates a quality of the second link between the second CD and the access network node.

17. The network node of claim 13, further comprising:
determining a second set of one or more IRS configuration parameters, wherein the second set of IRS configuration parameter comprises at least one of: (a) a second link quality metric for a second link between a second CD and the access network node, wherein the second link comprises a third channel between the second CD and the set of one or more IRSs and a fourth channel between the set of one or more IRSs and the access network node; (b) a second QoS requirement for the second CD; or (c) a transmission status for the second CD, wherein
partitioning the set of configurable reflectors comprises partitioning the set of configurable reflectors based on both the first set of IRS configuration parameters and the second set of IRS configuration parameters.
